(19) United States
(12) Patent Application Publication
(10) Pub. No.: US 2026/0302500 A1
(43) Pub. Date: Oct. 1, 2026

(54) ALL-SOLID RECHARGEABLE BATTERY MODULE

(71) Applicant: SAMSUNG SDI CO., LTD., Yongin-si, Gyeonggi-do (KR)

(72) Inventors: Myoungki MIN, Yongin-si, Gyeonggi-do (KR); Soomin HWANG, Yongin-si, Gyeonggi-do (KR); Seulchan PARK, Yongin-si, Gyeonggi-do (KR); Jaemin KIM, Yongin-si, Gyeonggi-do (KR); Sangkyu LEE, Yongin-si, Gyeonggi-do (KR); Sunghyun NOH, Yongin-si, Gyeonggi-do (KR)

(21) Appl. No.: 18/879,367

(22) PCT Filed: Apr. 4, 2024
(86) PCT No.: PCT/KR2024/004450

§ 371 Date: Dec. 27, 2024

(30) Foreign Application Priority Data
Nov. 15, 2023 (KR) 10-2023-0158556

(51) Int. Cl. H01M 50/293; H01M 10/0525; H01M 10/0585; H01M 50/291; H01M 50/446; H01M 50/491; H01M 50/497; H01M 50/54

(52) U.S. Cl. CPC H01M 50/293; H01M 10/0525; H01M 10/0585; H01M 50/291; H01M 50/446; H01M 50/491; H01M 50/497; H01M 50/54

(57) ABSTRACT

An all-solid rechargeable battery is provided. The all-solid rechargeable battery module includes unit cells of an all-solid rechargeable battery in which a negative electrode, a solid electrolyte layer, and a positive electrode are stacked, a flexible partition wall disposed on an outer side in a first direction and a second direction intersecting a stacking direction of the unit cells and disposed between the unit cells, and tab members disposed on both ends of the partition wall in the stacking direction to electrically connect the unit cells.

### BACKGROUND OF THE INVENTION

### (a) Field of the Invention

The present disclosure relates to an all-solid rechargeable battery module.

### (b) Description of the Related Art

Recently, in response to industrial demands, the development of batteries with high energy density and safety is being actively conducted. For example, lithium-ion batteries are being put into practical use not only in the fields of information-related devices and communication devices, but also in the automobile field. In the automotive field, they are particularly important because they are related to life.

Lithium-ion batteries currently on the market use electrolytes containing flammable organic solvents, so there is a possibility of overheating and fire in the event of a short circuit. In this regard, an all-solid rechargeable battery using a solid electrolyte instead of an electrolyte is being proposed.

Because the all-solid rechargeable battery does not use a flammable organic solvent, the possibility of fire or explosion in the event of a short circuit may be considerably reduced. Therefore, the all-solid battery may considerably increase safety compared to the lithium ion battery using the electrolyte solution.

The above information disclosed in this background section is only for enhancement of understanding of the background of the disclosure, and therefore it may contain information that does not form the prior art that is already known in this country to a person of ordinary skill in the art.

### SUMMARY OF THE INVENTION

An embodiment provides an all-solid rechargeable battery module having flexibility. Another embodiment provides an all-solid rechargeable battery module having flexibility and lithium ion conductivity.

An embodiment provides an all-solid rechargeable battery module including: unit cells of an all-solid rechargeable battery in which a negative electrode, a solid electrolyte layer, and a positive electrode are stacked, a flexible partition wall disposed on an outer side in a first direction and a second direction intersecting a stacking direction of the unit cells and disposed between the unit cells, and tab members disposed on both ends of the partition wall in the stacking direction to electrically connect the unit cells.

The unit cells may include negative electrodes disposed on one side in the stacking direction, and positive electrodes disposed on the other side in the stacking direction.

The tab members may include a first connection tab that connects current collectors of the negative electrodes disposed on one side in the stacking direction to each other, and a second connection tab that connects current collectors of the positive electrodes disposed on the other side in the stacking direction to each other.

The unit cells may include negative electrodes and positive electrodes that are alternatively disposed in the first direction and the second direction.

The tab members may include a first connection tab that connects a current collector of the negative electrode and a current collector of the positive electrode that are disposed on one side in the stacking direction, and a second connection tab that connects a current collector of the positive electrode and a current collector of the negative electrode that are disposed on the other side in the stacking direction.

The flexible partition wall may include a conductive binder of lithium ions.

The flexible partition wall may include a skeleton structure made of porous inorganic or organic material, and an ion-conductive polymer filled in the skeleton structure.

The porous inorganic material may include one of zeolite and SiO₂:

The porous organic material may include one of porous PTFE, and PE and PP materials used as rechargeable battery separators.

The ion conductive polymer may have pores or be used alone, and may include one of PVdF, PVdF-HFP, H-NBR, an acrylate binder, a PEO-based binder, LiTFSI, LiFSI, LiCFSI, LiBF₄, LiClO₄, LiAsF₆, LiCF₃SO₃, LiPF₆, and may be a mixture material with a salt and has a Li ion conductivity of 10⁻³ S/cm to 10⁻⁶ S/cm.

In the flexible partition wall, the skeleton structure may have a volume ratio of 0% to 40%, and a volume ratio of the organic material to the binder and the salt may be 60% to 100%.

The flexible partition wall may have a relative ratio of ionic conductivity of 51% to 100%.

The flexible partition wall may be made of an ion conductive polymer.

In the flexible partition wall, a ratio of a lithium salt to an organic material including a binder may be 10 wt % to 200 wt %.

The flexible partition wall may have a relative ratio of ionic conductivity of 75% to 100%.

An embodiment may provide flexibility in an all-solid rechargeable battery module by providing flexible partition walls on the outer periphery of the unit cells. In addition, the flexible partition walls of the embodiment include a conductive binder of lithium ions, thereby providing flexibility in an all-solid rechargeable battery module while preventing a decrease in cell performance due to a decrease in the conductivity of lithium ions.

### BRIEF DESCRIPTION OF THE DRAWINGS

FIG. 1 illustrates a longitudinal cross-sectional view of an all-solid rechargeable battery according to an embodiment.

FIG. 2 illustrates a longitudinal cross-sectional view of the formation of a lithium metal layer of an all-solid rechargeable battery according to an embodiment.

FIG. 3 illustrates a top plan view of an all-solid rechargeable battery module according to a first embodiment of the present disclosure.

FIG. 4 illustrates a cross-sectional view taken along line IV-IV of FIG. 3.

FIG. 5 illustrates a cross-sectional view of an all-solid rechargeable battery module according to a second embodiment of the present disclosure.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

In addition, unless explicitly stated to the contrary, the word “comprise” and variations such as “comprises” and “comprising” should be understood to imply the inclusion of stated elements but not the exclusion of any other elements.

In the drawings, the thicknesses of layers, films, panels, areas, regions, and the like are exaggerated for clarity, and like reference numerals designate like elements throughout the specification. It will be understood that when an element such as a layer, film, area, region, or substrate is referred to as being “on” or “above” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface. Here “or” is not to be construed as an exclusive meaning, and for example, “A or B” is construed to include A, B, A+B, and the like.

Positive Electrode for all-Solid Rechargeable Battery

In an embodiment, a positive electrode for an all-solid rechargeable battery including a current collector and a positive electrode active material layer disposed on the current collector is provided, wherein the positive electrode active material layer includes a positive electrode active material, a sulfide-based solid electrolyte, a fluorine-based resin binder, and a vanadium oxide.

The positive electrode for the all-solid recharge battery is manufactured by applying a positive electrode composition including a positive electrode active material, a sulfide-based solid electrolyte, a fluorine-based resin binder, and a vanadium oxide to a current collector, followed by drying and roll-pressing.

The positive electrode composition generally becomes strongly basic due to residual lithium such as LiOH or other components, which may cause gelation or agglomeration of the fluorine-based resin binder. However, according to an embodiment, when a vanadium oxide is added, gelation of the fluorine-based resin binder is suppressed, and accordingly, the viscosity of the positive electrode composition is maintained, thereby ensuring processibility. Furthermore, there is no need to use a neutralizing agent, and the like, so deterioration of the sulfide-based solid electrolyte due to the neutralizing agent may be prevented, thereby improving performance of the all-solid rechargeable battery.

### Vanadium Oxide

The vanadium oxide is a component that is insoluble in a solvent of the positive electrode composition, and may control the strong basicity of the positive electrode composition to prevent gelation of the fluorine-based resin binder, and at the same time, suppress deterioration of the sulfide-based solid electrolyte to improve the ionic conductivity of a positive electrode. It is understood that the vanadium oxide controls pH through physical and/or chemical reactions with —OH groups in the positive electrode composition in a strong base state, and accordingly, suppresses gelation of the fluorine-based resin binder. Compared to other transition metal oxides such as titanium oxide and tungsten oxide, the vanadium oxide has a more excellent ability to control basicity and suppress gelation of the fluorine-based resin binder, has low reactivity with the sulfide-based solid electrolyte, and may suppress deterioration of the sulfide-based solid electrolyte to improve the ionic conductivity and overall performance of the all-solid rechargeable battery.

The vanadium oxide may include, for example, V₂O₃, VO₂, V₂O₄, V₂O₅, or a combination thereof. In addition, the vanadium oxide may be included in an amount of 0.01 wt % to 5 wt % with respect to 100 wt % of the positive electrode active material layer, for example, 0.05 wt % to 5 wt %, 0.1 wt % to 5 wt %, 0.5 wt % to 5 wt %, or 0.5 wt % to 3 wt %. When the vanadium oxide is included in the aforementioned amount, the viscosity of the positive electrode composition may be appropriately maintained without deterioration in capacity, thereby improving processibility and improving the ionic conductivity of the positive electrode.

According to an exemplary embodiment, the positive electrode composition is coated on the current collector in a state in which the vanadium oxide is added and dispersed in the positive electrode composition. Therefore, the vanadium oxide may be in the form of being dispersed in the manufactured positive electrode active material layer. This is different from a form in which the vanadium oxide is coated on a surface of the positive electrode active material or sulfide-based solid electrolyte.

In one example, the vanadium oxide may be a pentavalent vanadium oxide (vanadium(V) oxide), in which case the melting point of the vanadium oxide may be 1000° C. or lower, for example, 600° C. to 800° C., or 650° C. to 690° C. The pentavalent vanadium oxide is excellent in terms of suppressing gelation of the fluorine-based resin binder in the positive electrode and is advantageous for improving the overall battery performance.

In addition, the vanadium oxide may be in the form of a particle, and an average particle diameter (D50) thereof may be 10 nm to 10 μm, for example, 10 nm to 5 μm, 10 nm to 3 μm, 50 nm to 1 μm, 50 nm to 500 nm, or 500 nm to 1 μm. The vanadium oxide with these physical properties is suitable for addition to the positive electrode composition and may effectively suppress gelation of the positive electrode composition without adversely affecting the positive electrode. If the particle diameter of the vanadium oxide is too small, the vanadium oxide may not be properly dispersed in the positive electrode, blocking migration paths of electrons and ions, which may deteriorate the battery performance, or may not sufficiently perform its role to suppress gelation of the binder. On the other hand, if the particle diameter of the vanadium oxide is too large, the vanadium oxide may block the migration paths of electrons and ions, deteriorating the battery performance.

### Fluorine-Based Resin Binder

The fluorine-based resin binder may be a general resin binder containing fluorine, and may include, for example, polyvinylidene fluoride, polyvinylidene fluoride-hexafluoropropylene copolymer, polyvinylidene fluoride-trichloroethylene copolymer, polyvinylidene fluoride-chlorotrifluoroethylene copolymer, polytetrafluoroethylene, or a combination thereof.

A weight average molecular weight of the fluorine-based resin binder may be approximately 50 kDa to 5,000 kDa, or 100 kDa to 2000 kDa. In addition, the glass transition temperature of the fluorine-based resin binder may be −10° C. or lower, and the melting point thereof may be 100° C. or higher. The melting viscosity of the fluorine-based resin binder may be about 10 kP to 50 kP. Furthermore, the fluorine-based resin binder may be in the form of a particle and an average particle diameter thereof may be approximately 50 nm to 200 μm. The fluorine-based resin binder with these physical properties may implement excellent adhesive force even when it is added to the positive electrode composition in a small amount and may increase the durability of the battery without adversely affecting the battery performance.

The fluorine-based resin binder may be included in an amount of 0.1 wt % to 10 wt %, for example, 0.1 wt % to 8 wt %, 0.1 wt % to 6 wt %, 0.1 wt % to 5 wt %, 0.5 wt % to 4 wt %, or 1 wt % to 3 wt % with respect to 100 wt % of the positive electrode active material layer. When the fluorine-based resin binder is included in the above content range, excellent adhesive force may be exhibited without adversely affecting the positive electrode.

### Positive Electrode Active Material

The positive electrode active material may be applied without limitation as long as it is generally used in all-solid rechargeable batteries. For example, the positive electrode active material may be a compound capable of reversible intercalation and deintercalation of lithium, and may include a compound represented by any one of the following chemical formulas.

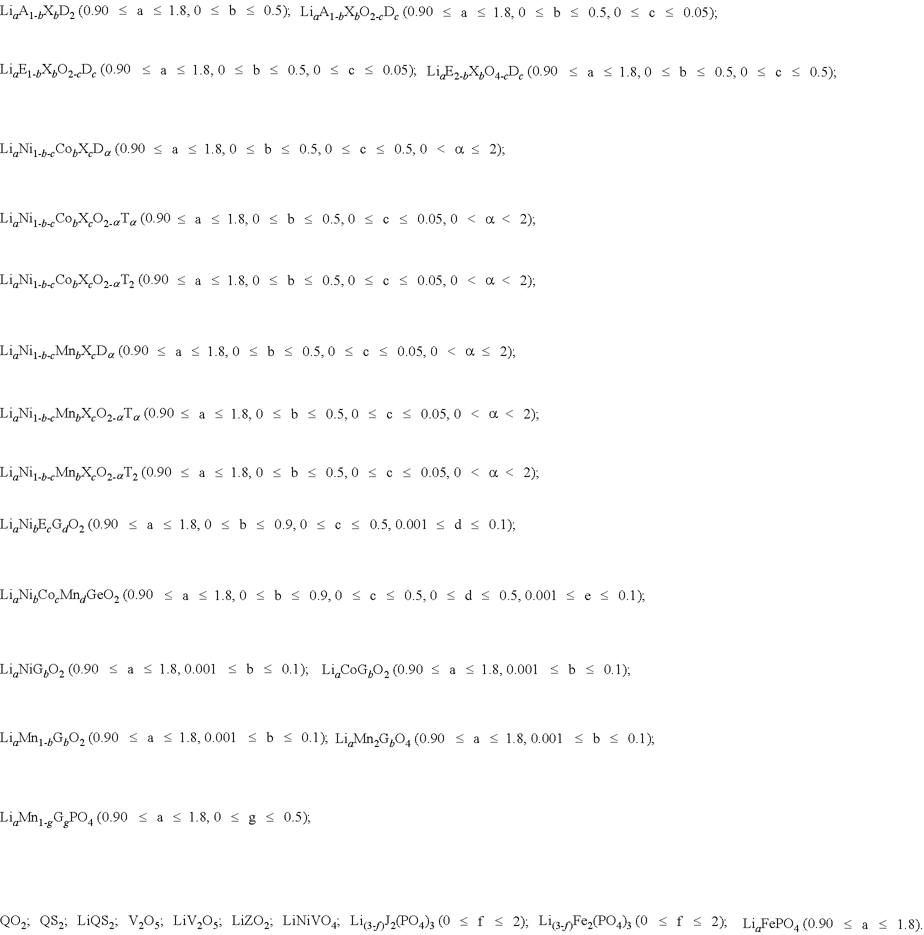

In the above chemical formulas, A is selected from the group consisting of Ni, Co, Mn, and a combination thereof, X is selected from the group consisting of Al, Ni, Co, Mn, Cr, Fe, Mg, Sr, V, rare earth elements, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The positive electrode active material may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), and lithium nickel manganese oxide (NM), lithium manganese oxide (LMO), or lithium ferrous phosphate oxide (LFP).

The positive electrode active material may include a lithium nickel-based oxide represented by Chemical Formula 1 below, a lithium cobalt-based oxide represented by Chemical Formula 2 below, a lithium ferrous phosphate-based compound represented by Chemical Formula 3 below, or a combination thereof.

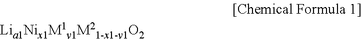

In Chemical Formula 1, 0.9≤a1≤1.8, 0.3≤x1≤1, 0≤y1≤0.7, and M1 and M2 are each one or more elements independently selected from the group consisting of Al, B, Ba, Ca, Ce, Co, Cr, Cu, F, Fe, Mg, Mn, Mo, Nb, P, S, Si, Sr, Ti, V, W, and Zr.

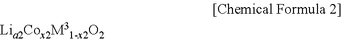

In Chemical Formula 2, 0.9≤a2≤1.8, 0.6≤x2≤1, and M3 is one or more elements selected from the group consisting of Al, B, Ba, Ca, Ce, Cr, Cu, F, Fe, Mg, Mn, Mo, Nb, P, S, Si, Sr, Ti, V, W, and Zr.

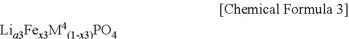

In Chemical Formula 3, 0.9≤a3≤1.8, 0.6≤x3≤1, and M4 is one or more elements selected from the group consisting of Al, B, Ba, Ca, Ce, Co, Cr, Cu, F, Fe, Mg, Mn, Mo, Nb, P, S, Si, Sr, Ti, V, W, and Zr.

An average particle diameter (D50) of the positive electrode active material may be 1 μm to 25 μm, for example, 3 μm to 25 μm, 5 μm to 25 μm, 5 μm to 20 μm, 8 μm to 20 μm, or 10 μm to 18 μm. The positive electrode active material having the particle diameter range may be harmoniously mixed with other components in the positive electrode active material layer and may implement the high capacity and high energy density.

The positive electrode active material may be in the form of a secondary particle made by agglomeration of a plurality of primary particles, or may be in the form of a single particle. In addition, the positive electrode active material may be spherical or close to a spherical shape, or may be polyhedral or amorphous.

### Sulfide-Based Solid Electrolyte

The sulfide-based solid electrolyte may include, for example, Li₂S—P₂S₅, Li₂S—P₂S₅—LiX (X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer, and Z is Ge, Zn, or Ga), Li₂S—GeS₂, Li₂S—SiS₂—Li₃PO₄, Li₂S—SiS₂-LiₚMO_{q} (p and q are integers, and M is P, Si, Ge, B, Al, Ga, or In), or a combination thereof.

The sulfide-based solid electrolyte may be obtained by, for example, mixing Li₂S and P₂S₅ at a molar ratio of 50:50 to 90:10 or 50:50 to 80:20 and optionally heat treating the mixture. Within the above mixing ratio range, the sulfide-based solid electrolyte having excellent ionic conductivity may be manufactured. Here, SiS₂, GeS₂, B₂S₃, and the like as other components may be further included to further improve the ionic conductivity.

A mechanical milling or solution method may be applied as a method of mixing sulfur-containing raw materials to prepare the sulfide-based solid electrolyte. The mechanical milling is a method of particulating and mixing starting materials by putting the starting materials, a ball mill, and the like in a reactor and stirring strongly the mixture. When using the solution method, the solid electrolyte may be obtained as a precipitate by mixing the starting materials in a solvent. In addition, when heat treatment is performed after mixing, crystals of the solid electrolyte may become more robust and the ionic conductivity may be improved. As an example, the sulfide-based solid electrolyte may be prepared by mixing sulfur-containing raw materials and heat-treating the sulfur-containing raw materials twice. In this case, the sulfide-based solid electrolyte having high ionic conductivity and robustness may be prepared.

As an example, the sulfide-based solid electrolyte particles may contain argyrodite type sulfide. The argyrodite-type sulfide may be represented by, for example, Chemical Formula of LiₐM_{b}P_{c}S_{d}Aₑ (a, b, c, d, and e are all 0 or greater and 12 or less, M is Ge, Sn, Si, or a combination thereof, and A is F, Cl, Br, or I), and specifically, may be represented by Chemical Formula of Li₇₋ₓPS₆₋ₓAₓ (x is 0.2 or greater and 1.8 or less, and A is F, Cl, Br, or I). The argyrodite-type sulfide may be specifically Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or the like.

The sulfide-based solid electrolyte particles containing such azirodite type sulfide may have high ionic conductivity close to the range of 10⁻⁴ to 10⁻² S/cm, which is ionic conductivity of a typical liquid electrolyte at room temperature, and may form a tight bond between the positive active material and the solid electrolyte without causing the decrease in the ion conductivity, and further form a tight interface between the electrode layer and the solid electrolyte layer. The all-solid rechargeable battery containing this may improve the performance of the battery such as rate characteristics, coulombic efficiency, and lifespan characteristics.

The ajirodite type sulfide-based solid electrolyte may be prepared by, for example, mixing lithium sulfide, phosphorus sulfide, and optionally lithium halide. After mixing them, the heat treatment may be performed. The heat treatment may include, for example, two or more heat treatment steps.

The average particle size D50 of the sulfide-based solid electrolyte particles according to an embodiment may be 5.0 μm or less and may be, for example, 0.1 μm to 5.0 μm, 0.1 μm to 4.0 μm, 0.1 μm to 3.0 μm, 0.5 μm to 2.0 μm, or 0.1 μm to 1.5 μm. Alternatively, the sulfide-based solid electrolyte particles may be small particles having the average particle size D50 of 0.1 μm to 1.0 μm depending on the location or purpose of use, or may be large particles having an average particle size D50 of 1.5 μm to 5.0 μm. The sulfide-based solid electrolyte particles in this particle size range may effectively penetrate between the solid particles in the battery, and have excellent contactability with the electrode active material and the connectivity between the solid electrolyte particles. The average particle size of the sulfide-based solid electrolyte particles may be measured using a microscope image. For example, the particle size distribution may be obtained by measuring the size of about 20 particles in a scanning electron microscope image, and the D50 may be calculated from the particle size distribution.

The content of the solid electrolyte in the positive electrode for the all-solid rechargeable battery may be 0.5 wt % to 35 wt % and may be, for example, 1 wt % to 35 wt %, 5 wt % to 30 wt %, and 8 wt % to 25 wt %, or 10 wt % to 20 wt %. This is the content relative to the total weight of the components in the positive electrode, and specifically, may be the content relative to the total weight of the positive electrode active material layer.

In the embodiment, the positive electrode active material layer contains 50 wt % to 99.35 wt % of positive electrode active material, 0.5 wt % to 35 wt % of sulfide-based solid electrolyte, and 0.1 wt % to 10 wt % of fluorinated resin binder, and 0.05 wt % to 5 wt % of vanadium oxide, based on 100 wt % of positive electrode active material layer. When this content range is satisfied, the positive electrode for the all-solid rechargeable battery maintains the high adhesion while maintaining the high capacity and high ionic conductivity, and maintains the viscosity of the positive electrode composition at an appropriate level, thereby improving the processability.

### Conductive Material

The positive electrode active material layer may further include a conductive material. The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber containing copper, nickel, aluminum, silver, and the like; a conductive polymer such as a polyphenylene derivative; or a combination thereof.

The conductive material may be included in an amount of 0.1 wt % to 5 wt %, or 0.1 wt % to 3 wt % with respect to a total weight of each component of the positive electrode for an all-solid battery, or with respect to the total weight of the first positive electrode active material layer. Within the above content range, the conductive material may improve electrical conductivity without deteriorating battery performance.

When the positive electrode active material layer further includes a conductive material, the positive electrode active material layer may include 45 wt % to 99.25 wt % of the positive electrode active material, 0.5 wt % to 35 wt % of the sulfide-based solid electrolyte, 0.1 wt % to 10 wt % of the fluorine-based resin binder, 0.05 wt % to 5 wt % of the vanadium oxide, and 0.1 wt % to 5 wt % of the conductive material with respect to 100 wt % of the positive electrode active material layer.

Meanwhile, the positive electrode for a lithium rechargeable battery may further include an oxide-based inorganic solid electrolyte, in addition to the solid electrolyte described above. The oxide-based inorganic solid electrolyte may include, for example, Li₁₊ₓTi₂₋ₓAl PO₄₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB (Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y} PO₄₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, garnet-based ceramics Li₃₊ₓLa₃M₂O₁₂ (M=Te, Nb, or Zr; x is an integer from 1 to 10), or a combination thereof.

### All-Solid Rechargeable Battery

An embodiment provides an all-solid rechargeable battery including the positive electrode described above, a negative electrode, and a solid electrolyte layer disposed between the positive electrode and the negative electrode. The all-solid rechargeable battery may be referred to as an all-solid battery or an all-solid lithium rechargeable battery.

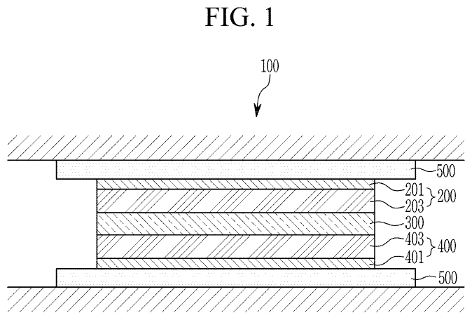

FIG. 1 illustrates a cross-sectional view of an all-solid rechargeable battery according to an embodiment. Referring to FIG. 1, an all-solid rechargeable battery module battery 100 may have a structure in which an electrode assembly in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked is accommodated in a case such as a pouch. The all-solid battery 100 may further include an elastic layer 500 on an outer side of at least one of the positive electrode 200 and the negative electrode 400. Although FIG. 1 shows one electrode assembly including the negative electrode 400, the solid electrolyte layer 300, and the positive electrode 200, an all-solid battery may be manufactured by stacking two or more electrode assemblies.

### Negative Electrode

The negative electrode for an all-solid battery may include, for example, a current collector and a negative electrode active material layer disposed on the current collector. The negative electrode active material layer includes a negative electrode active material and may further include a binder, a conductive material, and/or a solid electrolyte.

The negative electrode active material may include a material capable of reversibly intercalation/deintercalating lithium ions, lithium metal, an alloy of lithium metal, a material capable of being doped and undoped on lithium, or a transition metal oxide.

The material capable of reversibly intercalating/deintercalating lithium ions is a carbon-based negative electrode active material, and may include, for example, crystalline carbon, amorphous carbon, or a combination thereof. Examples of the crystalline carbon may include graphite such as amorphous, plate-like, flake-like, spherical or fibrous natural graphite or artificial graphite, and examples of the amorphous carbon may include soft carbon or hard carbon, mesophase pitch carbide, fired coke, and the like.

For the alloy of the lithium metal, an alloy of lithium and one or more metal selected from Na, K, Rb, Cs, Fr, Be, Mg, Ca, Sr, Si, Sb, Pb, In, Zn, Ba, Ra, Ge, Al and Sn may be used

For the material capable of being doped or undoped on the lithium, a Si-based negative electrode active material or an Sn-based negative electrode active material may be used. Examples of the Si-based negative electrode active material may include silicon, silicon-carbon composite, SiOₓ (0<x<2), and a Si-Q alloy (Q is an element selected from the group consisting of alkali metals, alkali earth metals, Group 13 elements, Group 14 elements, Group 15 elements, Group 16 elements, transition metals, rare-earth elements, and combinations thereof, but is not Si). Examples of the Sn-based negative electrode active material may include Sn, SnO₂, a Sn—R alloy (R is an element selected from the group consisting of alkali metals, alkali earth metals, Group 13 elements, Group 14 elements, Group 15 elements, Group 16 elements, transition metals, rare-earth elements, and combinations thereof, but is not Sn). In addition, a mixture of at least one thereof and SiO₂ may be used. The elements Q and R may be selected and used from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and a silicon particle and an amorphous carbon coating layer positioned on a surface of the core. The crystalline carbon may be artificial graphite, natural graphite, or a combination thereof. As the amorphous carbon precursor, coal-based pitch, mesophase pitch, petroleum-based pitch, coal-based oil, petroleum-based heavy oil, or polymer resin such as phenol resin, furan resin, and polyimide resin may be used. In this case, a content of silicon may be 10 wt % to 50 wt % with respect to a total weight of the silicon-carbon composite. In addition, a content of the crystalline carbon may be 10 wt % to 70 wt % with respect to the total weight of the silicon-carbon composite, and a content of the amorphous carbon may be 20 wt % to 40 wt % with respect to the total weight of the silicon-carbon composite. In addition, a thickness of the amorphous carbon coating layer may be 5 nm to 100 nm.

An average particle diameter (D50) of the silicon particle may be 10 nm to 20 μm, and for example, 10 nm to 500 nm. The silicon particle may be present in an oxidized form, and in this case, an atomic content ratio of Si:O in the silicon particle, which indicates a degree of oxidation, may be 99:1 to 33:67. The silicon particle may be a SiOₓ particle, in which case a range of x in SiOₓ may be greater than 0 and less than 2. Here, the average particle diameter (D50) is measured with a particle size analyzer using a laser diffraction method and refers to a diameter of a particle with a cumulative volume of 50% by volume in the particle size distribution.

The Si-based negative electrode active material or Sn-based negative electrode active material may be used by mixing with a carbon-based negative electrode active material. A mixing ratio of the Si-based negative electrode active material or Sn-based negative electrode active material and the carbon-based negative electrode active material may be 1:99 to 90:10 at a weight ratio.

The content of the negative electrode active material in the negative electrode active material layer may be 95 wt % to 99 wt % with respect to the total weight of the negative electrode active material layer.

In an embodiment, the negative electrode active material layer further includes a binder, and optionally, may further include a conductive material. The content of the binder in the negative electrode active material layer may be 1 wt % to 5 wt % with respect to the total weight of the negative electrode active material layer. In addition, when a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to adhere the negative electrode active material particles to each other well and also to adhere the negative electrode active material to the current collector well. The binder may include a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

Examples of the water-soluble binder may include a rubber-based binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluoro rubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, alkali metal salts thereof, or a combination thereof. As the alkali metal, Na, K, or Li may be used. An amount of the thickener used may be 0.1 to 3 parts by weight with respect to 100 parts by weight of the negative electrode active material.

The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for the all-solid battery may be a precipitation-type negative electrode. The precipitation-type negative electrode refers to a negative electrode which does not include a negative electrode active material during assembling of a battery but in which lithium metal or the like is precipitated during charging of the battery and serves as a negative electrode active material.

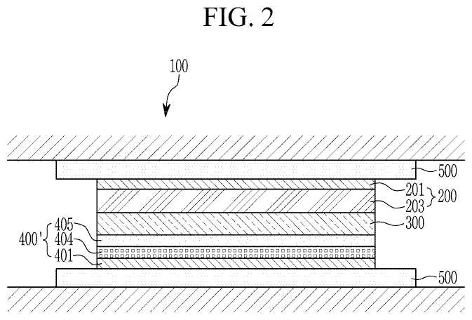

FIG. 2 illustrates a schematic cross-sectional view of an all-solid rechargeable battery including a precipitation-type negative electrode according to an embodiment. Referring to FIG. 2, a precipitation-type negative electrode 400′ may include a current collector 401 and a negative electrode coating layer 405 disposed on the current collector. In an all-solid battery having the precipitation-type negative electrode 400′, initial charging begins in the absence of a negative electrode active material, and during the charging, lithium metal with a high density or the like is precipitated between the current collecting layer 401 and the negative electrode coating layer 405 and forms a lithium metal layer 404, which may serve as a negative electrode active material. Accordingly, in an all-solid rechargeable battery that has been charged once or more, the precipitation-type negative electrode 400′ may include the current collector 401, the lithium metal layer 404 disposed on the current collector, and the negative electrode coating layer 405 disposed on the metal layer. The lithium metal layer 404 refers to a layer of lithium metal or the like precipitated during the charging process of the battery and may be called a metal layer or a negative electrode active material layer.

The negative electrode coating layer 405 may include metal, a carbon material, or a combination thereof that serves as a catalyst.

The metal may include, for example, gold, platinum, palladium, silicon, silver, aluminum, bismuth, tin, zinc, or a combination thereof, and may be composed of one selected therefrom or an alloy of more than one thereof. When the metal is present in the form of a particle, an average particle diameter (D50) thereof may be about 4 μm or less, for example, 10 nm to 4 μm.

The carbon material may be, for example, crystalline carbon, amorphous carbon, or a combination thereof. The crystalline carbon may be, for example, natural graphite, artificial graphite, a mesophase carbon microbead, or a combination thereof. The amorphous carbon may be, for example, carbon black, activated carbon, acetylene black, Denka black, Ketjen black, or a combination thereof.

When the negative electrode coating layer 405 includes both the metal and the carbon material, a mixing ratio of the metal and the carbon material may be, for example, 1:10 to 2:1 at a weight ratio. In this case, the precipitation of lithium metal may be effectively promoted and the characteristics of the all-solid battery may be improved. The negative electrode coating layer 405 may include, for example, a carbon material on which catalyst metal is supported, or a mixture of metal particles and carbon material particles.

The negative electrode coating layer 405 may include, for example, the metal and amorphous carbon, and in this case, the precipitation of lithium metal may be effectively promoted.

The negative electrode coating layer 405 may further include a binder, and the binder may be a conductive binder. Furthermore, the negative electrode coating layer 405 may further include general additives such as a filler, a dispersant, and an ion conductive material.

A thickness of the negative electrode coating layer 405 may be, for example, 100 nm to 20 μm, 500 nm to 10 μm, or 1 μm to 5 μm.

For example, the precipitation-type negative electrode 400′ may further include a thin film on the surface of the current collector, that is, between the current collector and the negative electrode coating layer. The thin film may contain an element that may form an alloy with lithium. The element that may form an alloy with lithium may be, for example, gold, silver, zinc, tin, indium, silicon, aluminum, bismuth, and the like, which may be used alone or as an alloy of more than one thereof. The thin film may further planarize a precipitation shape of the lithium metal layer 404 and further improve the characteristics of the all-solid battery. The thin film may be formed by, for example, a vacuum deposition method, a sputtering method, a plating method, or the like. The thin film may have, for example, a thickness ranging from 1 nm to 500 nm.

### Solid Electrolyte Layer

The solid electrolyte layer 300 may include a sulfide-based solid electrolyte, an oxide-based solid electrolyte, and the like. The specific description of the sulfide-based solid electrolyte and the oxide-based solid electrolyte are the same as above.

In one example, the solid electrolyte included in the positive electrode 200 and the solid electrolyte included in the solid electrolyte layer 300 may include the same compound or different compounds. For example, when both the positive electrode 200 and the solid electrolyte layer 300 include an argyrodite-type sulfide-based solid electrolyte, the overall performance of the all-solid rechargeable battery may be improved. Furthermore, as an example, when both the positive electrode 200 and the solid electrolyte layer 300 include the coated solid electrolyte described above, the all-solid rechargeable battery may implement excellent initial efficiency and life characteristics while implementing a high capacity and a high energy density.

Meanwhile, the average particle diameter (D50) of the solid electrolyte included in the positive electrode 200 may be smaller than the average particle diameter (D50) of the solid electrolyte included in the solid electrolyte layer 300. In this case, the overall performance may be improved by maximizing the energy density of the all-solid battery and increasing the mobility of lithium ions. For example, the average particle diameter (D50) of the solid electrolyte included in the positive electrode 200 may be 0.1 μm to 1.0 μm, or 0.1 μm to 0.8 μm, and the average particle diameter (D50) of the solid electrolyte included in the solid electrolyte layer 300 may be 1.5 μm to 5.0 μm, 2.0 μm to 4.0 μm, or 2.5 μm to 3.5 μm. When the above particle diameter ranges are satisfied, the energy density of the all-solid rechargeable battery is maximized and the transfer of lithium ions is facilitated, making it possible to suppress resistance and thus to improve the overall performance of the all-solid rechargeable battery. Here, the average particle diameter (D50) of the solid electrolyte may be measured with a particle size analyzer using a laser diffraction method. Alternatively, a particle size distribution may be obtained by measuring sizes of about 20 particles selected from a microscope image such as a scanning electron microscope, and a D50 value may be calculated from the particle size distribution.

The solid electrolyte layer may further include a binder, in addition to the solid electrolyte. In this case, for the binder, a styrene butadiene rubber, polytetrafluoroethylene, polyvinylidene fluoride, polyethylene, an acrylate-based polymer, or a combination thereof may be used, but the present invention is not limited thereto, and any binder used in the art may be used. The acrylate-based polymer may be, for example, butyl acrylate, polyacrylate, polymethacrylate, or a combination thereof.

The solid electrolyte layer may be formed by adding a solid electrolyte to a binder solution, coating a base film with the solution, and drying the resultant. The solvent for the binder solution may be isobutyryl isobutyrate, xylene, toluene, benzene, hexane, or a combination thereof. A process of forming the solid electrolyte layer is widely known in the art, and therefore, a detailed description will be omitted.

A thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. A content of the lithium salt in the solid electrolyte layer may be 1 M or more, for example, 1 M to 4 M. In this case, the lithium salt may improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato)borate (LiDFOB), lithium bis(trifluoro methanesulfonyl)imide, LiTFSI, LiN(SO₂CF₃)₂), lithium bis(fluorosulfonyl)imide LiFSI, LiN(SO₂F)₂), LiCF₃SO₃, LiAsF₆, LiSbF₆, LiClO₄, or a mixture thereof.

Furthermore, the lithium salt may be an imide-based salt. For example, the imide-based lithium salt include may lithium bis(trifluoro methanesulfonyl)imide, LiTFSI, LiN(SO₂CF₃)₂), lithium bis(fluorosulfonyl)imide, LiFSI, LiN(SO₂F)₂). The lithium salt may maintain or improve ionic conductivity by appropriately maintaining chemical reactivity with an ionic liquid.

The ionic liquid refers to a salt or a room temperature molten salt that has a melting point equal to or lower than a room temperature, is in a liquid state at room temperature and is composed of only ions.

The ionic liquid may be a compound including a) one or more cations selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, and triazolium-based cations and a mixture thereof, and b) BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from the group consisting of N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. The solid electrolyte layer that satisfies the above ranges may maintain or improve ionic conductivity by improving the electrochemical contact area with the electrode. Accordingly, the energy density, discharge capacity, rate characteristics, and the like of the all-solid battery may be improved.

The all-solid battery may include a unit cell having a structure of a positive electrode/a solid electrolyte layer/a negative electrode, a bi-cell structure having a structure of a positive electrode/a solid electrolyte layer/a negative electrode/a solid electrolyte layer/a positive electrode, or a stacked battery in which a structure of a unit battery is repeated.

A shape of the all-solid battery is not particularly limited, and may be, for example, a coin shape, a button shape, a sheet shape, a stack shape, a cylindrical shape, a flat shape, or the like. In addition, the all-solid battery may also be applied to large-sized batteries used in electric vehicles, and the like. For example, the all-solid battery may also be used in a hybrid vehicle such as a plug-in hybrid electric vehicle (PHEV). Furthermore, it may be used in fields that require a large amount of power storage, and for example, may also be used to an electric bicycle, an electric tool or the like.

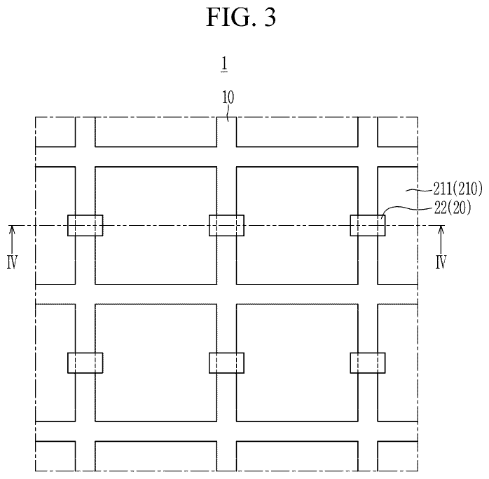

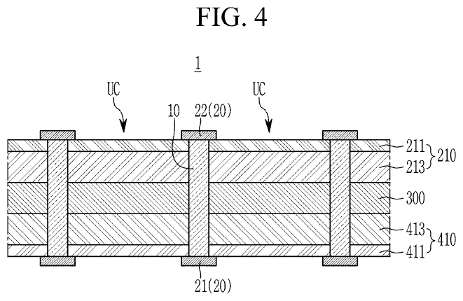

FIG. 3 illustrates a top plan view of an all-solid rechargeable battery module according to a first embodiment of the present disclosure, and FIG. 4 illustrates a cross-sectional view taken along line IV-IV of FIG. 3.

Referring to FIG. 3 and FIG. 4, an all-solid state rechargeable battery module 1 of the first embodiment includes unit cells UC, a flexible partition wall 10, and tab members 20.

The unit cells UC are formed as an all-solid rechargeable battery including a negative electrode 410, a solid electrolyte layer 310, and a positive electrode 210, which are stacked. The cross-section positive electrode 210 has a positive electrode active material layer 213 on one surface of a positive electrode current collector 211. The positive electrode active material layer 213 may be formed by coating a positive electrode active material slurry on one surface of the positive electrode current collector 211 or by bonding a solvent-free positive electrode active material thereonto.

The negative electrode 410 may have a negative electrode active material layer 413 on a negative electrode current collector 411. The solid electrolyte layer 300 may be formed as a film by directly coating a solid electrolyte film on the negative electrode active material layer 413.

The partition wall 10 is disposed on the outer side in the first direction (x-axis direction) and the second direction (y-axis direction) intersecting the stacking direction (z-axis direction) of the unit cells UC and is disposed between neighboring unit cells UC. The partition wall 10 provides flexibility in the first direction (x-axis direction) and the second direction (y-axis direction) in the all-solid rechargeable battery module 1 due to its flexibility.

In addition, the partition wall 10 includes a conductive binder of lithium ions. The conductive binder of lithium ions compensates for the reduction in the conductivity of lithium ions in the all-solid rechargeable battery module 1 by providing flexibility to the partition wall 10 by including a polymer in the partition wall 10. Accordingly, performance reduction of the unit cells UC is prevented.

The partition wall 10 includes both a form in which a skeleton structure made of a porous inorganic or organic material is filled with an ion-conductive polymer and a form made of an ion-conductive polymer.

The partition wall 10 does not include any active material of the positive or negative electrode. The partition wall 10 has an electron conductivity of 10⁻⁸ S/cm or less. Materials that may be used as the partition wall 10 are porous inorganic materials, and structures with high porosity, such as zeolite and SiO₂, may be used as a skeleton.

In addition, the organic skeleton structure includes porous PTFE (70 to 80% porous product) and PE and PP materials used as rechargeable battery separators. The ion conductive materials that may enter this pore or be used alone are mixtures of PVdF, PVdF-HFP, H-NBR, acrylate binder, PEO-based binder and LiTFSI, LiFSI, LiCFSI, LiBF₄, LiClO₄, LiAsF₆, LiCF₃SO₃, LiPF₆ salts, and have a Li ion conductivity of 10⁻³ S/cm to 10⁻⁶ S/cm.

Table 1 shows the results of Experimental Examples 1 to 4 and Comparative Examples 1 to 2 for a partition wall 10 having a skeleton structure made of porous inorganic or organic material and filled with an ion-conductive polymer.

TABLE 1

| | | Organic | Ion |
|---|---|---|---|
| | | material/ | Conductivity |
| Volume | | Binder + | Relative |
| Ratio | Structure | Salt | Ratio (%) |
| Experimental | 0 | 100 | 100 |
| Example 1 | | | |
| Experimental | 10 | 90 | 85 |
| Example 2 | | | |
| Experimental | 25 | 75 | 64 |
| Example 3 | | | |
| Experimental | 40 | 60 | 51 |
| Example 4 | | | |
| Comparative | 55 | 45 | 2 |
| Example 1 | | | |
| Comparative | 65 | 35 | 1 |
| Example 2 | | | |

Referring to Table 1, when the porous partition wall 10 is provided, in Experimental Examples 1 to 4, the skeleton structure has a volume ratio of 0% to 40%, and the volume ratio of the organic material to the binder and the salt is 60% to 100%. As the skeleton structure increases from 0% to 40%, the volume ratio of the organic matter to the binder and the salt decreases from 100% to 60%. Accordingly, the relative ratio of the ion conductivity decreases from 100% to 51%.

The reason why the lower limit of the volume ratio of the skeleton structure is 0% is because when the volume ratio of the skeleton structure becomes 0, the volume ratio of the ion conductive organic material to the binder and the salt becomes 100% in the partition wall 10. In this case, the relative ratio of the ion conductivity is 100%. When the volume ratio of the skeletal structure exceeds 40%, the flexible characteristics of the partition wall 10 disappear, and the relative ratio of the ion conductivity in the partition 10 decreases proportionally.

Compared to Experimental Examples 1 to 4, Comparative Examples 1 and 2 have a volume ratio of the skeleton structure of 55% to 65%, and a volume ratio of the organic material and the binder and the salt of 45% to 35%. In this case, it can be seen that the relative ratio of the ion conductivity is significantly reduced to 2% and 1%. The relative ratio of the ion conductivity is based on the relative ratio of the ion conductivity of 100% in Experimental Example 1 in which the volume ratio of the skeleton structure is 0% and the volume ratio of the organic material to the binder and the salt is 100%.

Table 2 shows the results of Experimental Examples 1 to 4 and Comparative Examples 1 and 2 for the partition wall 10 made of an ion conductive polymer.

TABLE 2

| | | | Ion |
|---|---|---|---|
| | | | Conductivity |
| | Organic | | Relative |
| Weight | Material/ | | Ratio |
| Ratio | Binder | Salt | (%) |
| Experimental | 100 | 10 | 75 |
| Example 1 | | | |
| Experimental | 100 | 50 | 80 |
| Example 2 | | | |
| Experimental | 100 | 100 | 100 |
| Example 3 | | | |
| Experimental | 100 | 200 | 85 |
| Example 4 | | | |
| Comparative | 100 | 0 | 50 |
| Example 1 | | | |
| Comparative | 100 | 250 | 45 |
| Example 2 | | | |

Referring to Table 2, when the porous partition wall 10 is provided, in Experimental Examples 1 to 4, the ratio of the organic material including the binder to the lithium salt varies depending on the type of the organic material, and the lithium salt may be mixed at a ratio of 10 to 200 wt % relative to the organic material. This is because the ion conductivity decreases when the lithium salt is less than 10 wt %. In this case, the relative ratio of the ion conductivity is 75%. When the lithium salt exceeds 200 wt %, the lithium salt precipitates and hardens, so flexibility disappears. In this case, the relative ratio of the ion conductivity is 95%.

Compared to Experimental Examples 1 to 4, the weight ratio of the lithium salt in Comparative Examples 1 and 2 is 0% and 250%. In this case, it can be seen that the relative ratio of the ion conductivity is significantly reduced to 50% and 45%. The relative ratio of the ion conductivity is based on the fact that the relative ratio of the ion conductivity is 100% in the case of Experimental Example 3 in which the weight ratio of the organic material including the skeletal binder and the lithium salt is 100 wt % and 100 wt %. The unit cells UC have the negative electrodes 410 disposed on one side in the stacking direction and the positive electrodes 210 disposed on the other side in the stacking direction. The tab members 20 include a first connection tab 21 and a second connection tab 22. The first connection tab 21 connects the current collectors 411 of the negative electrodes 41 disposed on one side (lower side) in the stacking direction to each other, and the second connection tab 22 connects the current collectors 211 of the positive electrodes 210 disposed on the other side (upper side) in the stacking direction to each other.

The unit cells UC are connected in parallel by the first and second tabs 21 and 22. Therefore, the all-solid rechargeable battery module 1 may supply a large amount of power by forming a configuration in which multiple unit cells UC are connected in parallel.

Hereinafter, the second embodiment will be described. Compared to the first embodiment, descriptions of the same configurations will be omitted and descriptions of different configurations will be described.

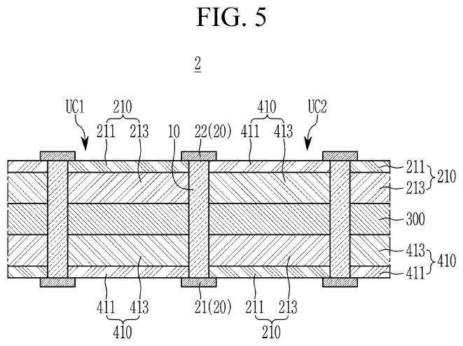

FIG. 5 illustrates a cross-sectional view of an all-solid rechargeable battery module according to a second embodiment of the present disclosure. Referring to FIG. 5, an all-solid rechargeable battery module 2 of the second embodiment includes a first unit cell UC1 and a second unit cell UC2.

For example, the first unit cell UC1 has a structure in which the positive electrode 210 is disposed on the upper side and the negative electrode 410 is disposed on the lower side. The second unit cell UC2 has a structure in which the negative electrode 410 is disposed on the upper side and the positive electrode 210 is disposed on the lower side.

Therefore, when the first and second unit cells UC1 and UC2 are sequentially disposed in the first and second directions, the negative electrode 410 and the positive electrode 210 are alternately disposed in the first and second directions.

The tab members 30 include a first connection tab 31 and a second connection tab 32. The first connection tab 31 connects the current collectors 411 and 211 of the negative and positive electrodes 41 disposed on one side (lower side) in the stacking direction to each other, and the second connection tab 32 connects the current collectors 211 and 411 of the positive and negative electrodes 210 and 410 disposed on the other side (upper side) in the stacking direction to each other.

The first and second unit cells UC1 and UC2 are connected in series by the first and second taps 31 and 32. Therefore, the all-solid rechargeable battery module 2 is configured to connect a plurality of first and second unit cells UC1 and UC2 in series, thereby being able to supply high-output power.

What has been described above is only one embodiment for carrying out the all-solid battery manufacturing method, the process plate, and the all-solid battery according to the same, according to the present disclosure. Therefore, the present disclosure is not limited to the above embodiments, and as claimed in the following claims, without departing from the gist of the present disclosure, it will be said that the technical features of the present disclosure are possible to the extent that various modifications may be made by a person with ordinary knowledge in the field to which the disclosure pertains.

### DESCRIPTION OF SYMBOLS

| | |
|---|---|
| 1, 2: | all-solid rechargeable battery module |
| 10: | partition wall |
| 20: | tab member |
| 21: | first connection tab |
| 22: | second connection tab |
| 30: | tab members |
| 31: | first connection tab |
| 32: | second connection tab |
| 210: | positive electrode |
| 211: | positive electrode current collector |
| 213: | positive electrode active material layer |
| 310: | solid electrolyte layer |
| 410: | Negative electrode |
| 411: | negative electrode current collector |
| 413: | negative electrode active material layer |
| UC: | unit cell |
| UC1: | first unit cell |
| UC2: | second unit cell |

What is claimed is:

1. An all-solid rechargeable battery module, comprising:
unit cells of an all-solid rechargeable battery in which a negative electrode, a solid electrolyte layer, and a positive electrode are stacked;
a flexible partition wall disposed on an outer side in a first direction and a second direction intersecting a stacking direction of the unit cells and disposed between the unit cells; and
tab members disposed on both ends of the partition wall in the stacking direction to electrically connect the unit cells.

2. The all-solid rechargeable battery module of claim 1, wherein:
the unit cells include:
negative electrodes disposed on one side in the stacking direction; and
positive electrodes disposed on the other side in the stacking direction.

3. The all-solid rechargeable battery module of claim 1, wherein:
the tab members include:
a first connection tab that connects current collectors of the negative electrodes disposed on one side in the stacking direction to each other; and
a second connection tab that connects current collectors of the positive electrodes disposed on the other side in the stacking direction to each other.

4. The all-solid rechargeable battery module of claim 1, wherein:
the unit cells include negative electrodes and positive electrodes that are alternatively disposed in the first direction and the second direction.

5. The all-solid rechargeable battery module of claim 1, wherein:
the tab members include:
a first connection tab that connects a current collector of the negative electrode and a current collector of the positive electrode that are disposed on one side in the stacking direction; and
a second connection tab that connects a current collector of the positive electrode and a current collector of the negative electrode that are disposed on the other side in the stacking direction.

6. The all-solid rechargeable battery module of claim 1, wherein:
the flexible partition wall includes a conductive binder of lithium ions.

7. The all-solid rechargeable battery module of claim 1, wherein:
the flexible partition wall includes:
a skeleton structure made of porous inorganic or organic material; and
an ion-conductive polymer filled in the skeleton structure.

8. The all-solid rechargeable battery module of claim 7, wherein:
the porous inorganic material includes one of zeolite and SiO₂:

9. The all-solid rechargeable battery module of claim 7, wherein:
the porous organic material includes one of porous PTFE, and PE and PP materials used as rechargeable battery separators.

10. The all-solid rechargeable battery module of claim 7, wherein:
the ion conductive polymer has pores or is used alone, and includes one of PVdF, PVdF-HFP, H-NBR, an acrylate binder, a PEO-based binder, LiTFSI, LiFSI, LiCFSI, LiBF₄, LiClO₄, LiAsF₆, LiCF₃SO₃, LiPF₆, and is a mixture material with a salt and has a Li ion conductivity of 10⁻³ S/cm to 10⁻⁶ S/cm.

11. The all-solid rechargeable battery module of claim 7, wherein:
in the flexible partition wall, the skeleton structure has a volume ratio of 0% to 40%, and a volume ratio of the organic material to the binder and the salt is 60% to 100%.

12. The all-solid rechargeable battery module of claim 11, wherein:
the flexible partition wall has a relative ratio of ionic conductivity of 51% to 100%.

13. The all-solid rechargeable battery module of claim 1, wherein:
the flexible partition wall is made of an ion conductive polymer.

14. The all-solid rechargeable battery module of claim 13, wherein:
in the flexible partition wall, a ratio of a lithium salt to an organic material including a binder is 10 wt % to 200 wt %.

15. The all-solid rechargeable battery module of claim 14, wherein:
the flexible partition wall has a relative ratio of ionic conductivity of 75% to 100%.
